(19) United States
(12) Patent Application Publication
(10) Pub. No.: US 2022/0012680 A1
(43) Pub. Date: Jan. 13, 2022

(54) DYNAMIC DISPATCH AND ROUTING BASED ON SENSOR INPUT

(71) Applicants: Lior SION, Tel Aviv (IL); BRINGG DELIVERY TECHNOLOGIES, LTD., Tel Aviv (IL)

(72) Inventor: Lior SION, Tel Aviv (IL)

(21) Appl. No.: 17/286,413

(22) PCT Filed: Oct. 16, 2019
(86) PCT No.: PCT/US2019/056621

§ 371 Date: Apr. 16, 2021

Related U.S. Application Data
(60) Provisional application No. 62/745,991, filed on Oct. 16, 2018.

(51) Int. Cl. G06Q 10/08; G06Q 10/06

(52) U.S. Cl. CPC G06Q 10/0832; G06Q 10/06315

(57) ABSTRACT

Systems and methods are disclosed for dynamic dispatch and routing based on sensor input. In one implementation, a first request is received with respect to a first item. One or more constraints associated with the first request are identified. One or more first inputs are received from a first sensor configured in relation to the first item. Based on (a) the one or more constraints and (b) the one or more inputs, a first dispatch instance is initiated. One or more second inputs are received. Based on the one or more second inputs, the first dispatch instance is adjusted.

### CROSS-REFERENCE TO RELATED APPLICATION

This application is related to and claims the benefit of U.S. Patent Application No. 62/745,991, filed Oct. 16, 2018, which is incorporated herein by reference in its entirety.

### TECHNICAL FIELD

Aspects and implementations of the present disclosure relate to data processing, and more specifically, to dynamic dispatch and routing based on sensor input.

### BACKGROUND

Various devices, such as smartphones, tablet devices, portable computers, etc., can incorporate multiple sensors. Such sensors can receive and/or provide inputs/outputs that reflect what is perceived by the sensor.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates an example device, in accordance with an example embodiment.

FIG. 3 is a flow chart illustrating a method, in accordance with example embodiments, for dynamic dispatch and routing based on sensor input.

FIG. 4 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to dynamic dispatch and routing based on sensor input.

It can be appreciated that existing technologies enable users to initiate operations and/or transactions with various establishments that are to be fulfilled in a relatively short period of time. For example, food delivery applications/services enable users to order groceries and other items for prompt or immediate delivery. While such services may be advantageous to both merchants and customers, certain scenarios may pose particular challenges. For example, certain operations or transactions can involve perishable items which must be delivered within a defined timeframe and/or under certain conditions. Existing technologies may treat such items like other (non-perishable) deliveries, resulting in potential health/safety and other risks.

Accordingly, described herein in various implementations are technologies are described herein that enable automated routing dispatch of such requests or orders, e.g., in order to account for various circumstances, constraints, and/or requirements. For example, as disclosed herein, the described technologies can account for the current state of an item (e.g., temperature) and project a future state of an item (e.g., how the temperature or other state(s) of the item is likely to change in 10, 20, 30, etc., minutes). The dispatch and routing of such items can be adjusted accordingly (e.g., to ensure that perishable items are delivered safely and satisfactorily), as described herein.

Accordingly, it can be appreciated that the described technologies are directed to and address specific technical challenges and longstanding deficiencies in multiple technical areas, including but not limited to sensor-based item state determination, route optimization, and device control/operation. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., (e.g., sensors, interfaces, etc.) operate to enable, improve, and/or enhance the described technologies, such as in a manner described herein.

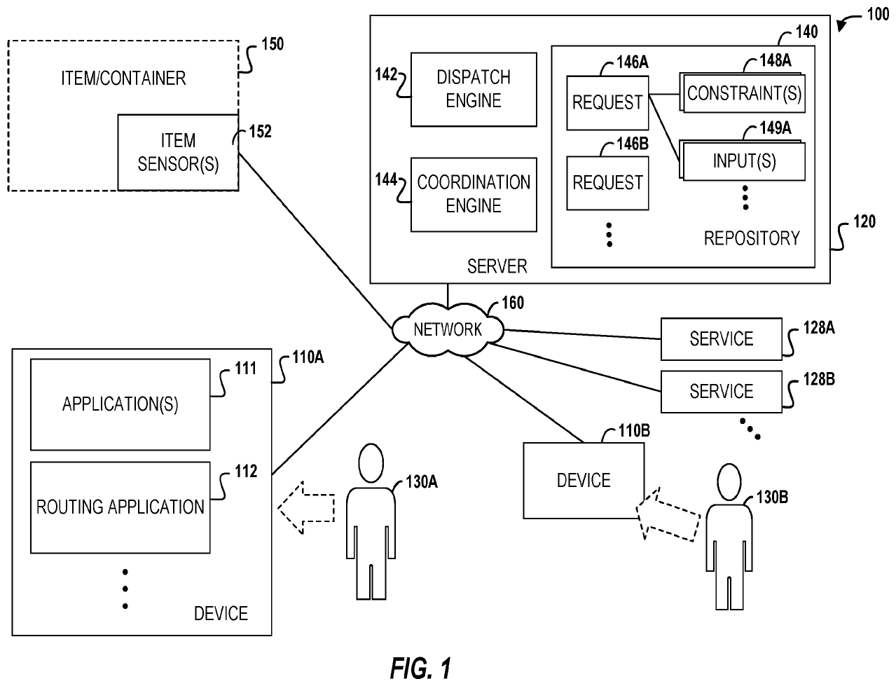

FIG. 1 depicts an illustrative system 100, in accordance with some implementations. As shown, system 100 includes device 110A and device 110B (collectively, devices 110), server 120, services 128A and 128B (collectively, services 128), item/container 150 (including sensor(s) 152). These (and other) elements or components can be connected to one another via network 160, which can be a public network (e.g., the Internet), a private network (e.g., a local area network (LAN) or wide area network (WAN)), or a combination thereof. Additionally, in certain implementations various elements may communicate and/or otherwise interface with one another.

Each of the referenced devices 110 can be, for example, a laptop computer, a desktop computer, a terminal, a mobile device, a smartphone, a tablet computer, a smart watch, a digital music player, a server, a wearable device, a virtual reality device, an augmented reality device, a holographic device, and the like. User 130A and user 130B (collectively, users 130) can be human users who interact with devices such as device 110A and device 110B, respectively. For example, user 130A can provide various inputs (e.g., via an input device/interface such as a keyboard, mouse, touchscreen, microphone—e.g., for voice/audio inputs, etc.) to device 110A. Device 110A can also display, project, and/or otherwise provide content to user 130A (e.g., via output components such as a screen, speaker, etc.). In certain implementations, a user may utilize multiple devices, and such devices may also be configured to operate in connection with one another (e.g., a smartphone and a smartwatch).

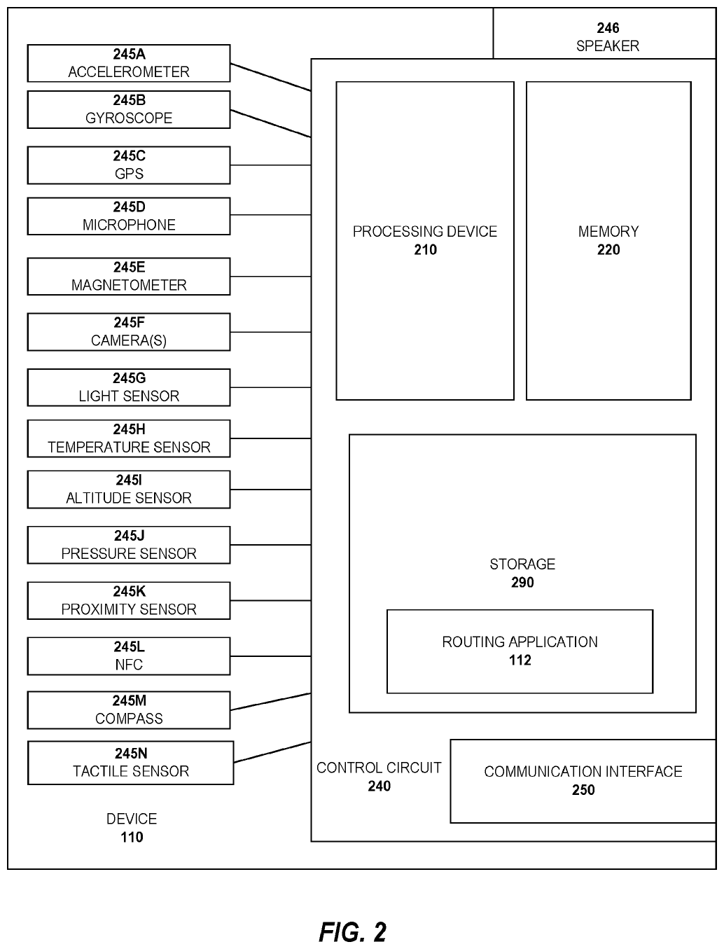

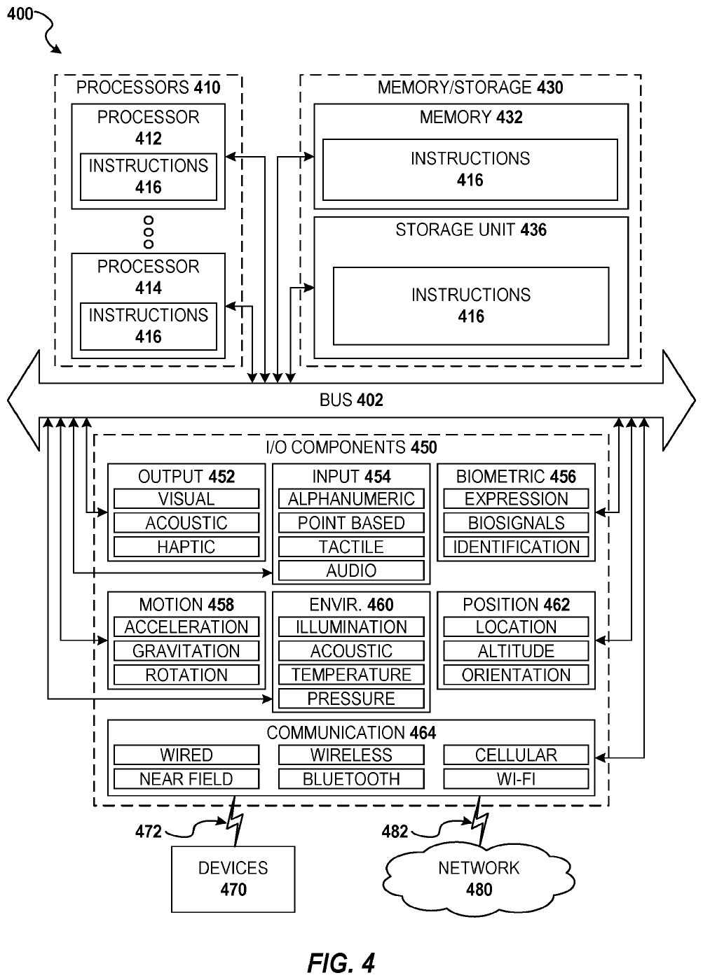

It should be understood that, in certain implementations, devices 110 can also include and/or incorporate various sensors and/or communications interfaces (including but not limited to those depicted in FIGS. 2 and 4 and/or described/referenced herein). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, etc. Additionally, in certain implementations devices 110 can be connected to and/or otherwise communicate with various peripheral devices.

By way of illustration, FIG. 2 depicts an example implementation of a device 110 (e.g., device 110A as shown in FIG. 1). As shown in FIG. 2, device 110 can include a control circuit 240 (e.g., a motherboard) operatively connected to various hardware and/or software components that serve to enable various operations, such as those described herein. Control circuit 240 can be operatively connected to processing device 210 and memory 220. Processing device 210 serves to execute instructions for software that can be loaded into memory 220. Processing device 210 can be a number of processors, a multi-processor core, or some other type of processor, depending on the particular implementation. Further, processor 210 can be implemented using a number of heterogeneous processor systems in which a main processor is present with secondary processors on a single chip. As another illustrative example, processor 210 can be a symmetric multi-processor system containing multiple processors of the same type.

Memory 220 and/or storage 290 may be accessible by processor 210, thereby enabling processing device 210 to receive and execute instructions stored on memory 220 and/or on storage 290. Memory 220 can be, for example, a random access memory (RAM) or any other suitable volatile or non-volatile computer readable storage medium. In addition, memory 220 can be fixed or removable. Storage 290 can take various forms, depending on the particular implementation. For example, storage 290 can contain one or more components or devices. For example, storage 290 can be a hard drive, a flash memory, a rewritable optical disk, a rewritable magnetic tape, or some combination of the above. Storage 290 also can be fixed or removable.

As shown in FIG. 2, storage 290 can store routing application 112. In certain implementations, routing application 112 can be, for example, instructions, an ‘app,’ etc., that can be loaded into memory 220 and/or executed by processing device 210, in order to enable a user of the device to interact with and/or otherwise utilize the technologies described herein (e.g., in conjunction with/communication with server 120).

A communication interface 250 is also operatively connected to control circuit 240. Communication interface 250 can be any interface (or multiple interfaces) that enables communication between user device 102 and one or more external devices, machines, services, systems, and/or elements (including but not limited to those depicted in FIG. 1 and described herein). Communication interface 250 can include (but is not limited to) a modem, a Network Interface Card (NIC), an integrated network interface, a radio frequency transmitter/receiver (e.g., WiFi, Bluetooth, cellular, NFC), a satellite communication transmitter/receiver, an infrared port, a USB connection, or any other such interfaces for connecting device 110 to other computing devices, systems, services, and/or communication networks such as the Internet. Such connections can include a wired connection or a wireless connection (e.g. 802.11) though it should be understood that communication interface 250 can be practically any interface that enables communication to/from the control circuit 240 and/or the various components described herein.

At various points during the operation of described technologies, device 110 can communicate with one or more other devices, systems, services, servers, etc., such as those depicted in FIG. 1 and/or described herein. Such devices, systems, services, servers, etc., can transmit and/or receive data to/from the user device 110, thereby enhancing the operation of the described technologies, such as is described in detail herein. It should be understood that the referenced devices, systems, services, servers, etc., can be in direct communication with user device 110, indirect communication with user device 110, constant/ongoing communication with user device 110, periodic communication with user device 110, and/or can be communicatively coordinated with user device 110, as described herein.

Also connected to and/or in communication with control circuit 240 of user device 110 are one or more sensors 245A-245N (collectively, sensors 245). Sensors 245 can be various components, devices, and/or receivers that can be incorporated/integrated within and/or in communication with user device 110. Sensors 245 can be configured to detect one or more stimuli, phenomena, or any other such inputs, described herein. Examples of such sensors 245 include, but are not limited to: accelerometer 245A, gyroscope 245B, GPS receiver 245C, microphone 245D, magnetometer 245E, camera 245F, light sensor 245G, temperature sensor 245H, altitude sensor 245I, pressure sensor 245J, proximity sensor 245K, near-field communication (NFC) device 245L, compass 245M, and tactile sensor 245N. As described herein, device 110 can perceive/receive various inputs from sensors 245 and such inputs can be used to initiate, enable, and/or enhance various operations and/or aspects thereof, such as is described herein.

At this juncture it should be noted that while the foregoing description (e.g., with respect to sensors 245) has been directed to user device 110, various other devices, systems, servers, services, etc. (such as are depicted in FIG. 1 and/or described herein) can similarly incorporate the components, elements, and/or capabilities described with respect to device 110. It should also be understood that certain aspects and implementations of various devices, systems, servers, services, etc., such as those depicted in FIG. 1 and/or described herein, are also described in greater detail below in relation to FIG. 4.

In certain implementations, device 110 can also include one or more application(s) 111 and routing application 112. Each of application(s) 111 and routing application 112 can be programs, modules, or other executable instructions that configure/enable the device to interact with, provide content to, and/or otherwise perform operations on behalf of a user. In certain implementations, such applications can be stored in memory of device 110 (e.g. memory 430 as depicted in FIG. 4 and described below). One or more processor(s) of device 110 (e.g., processors 410 as depicted in FIG. 4 and described below) can execute such application(s). In doing so, device 110 can be configured to perform various operations, present content to user 130, etc.

Examples of application(s) 111 include but are not limited to: internet browsers, mobile apps, ecommerce applications, social media applications, personal assistant applications, navigation applications, etc. By way of further illustration, application(s) 111 can include mobile apps that enable users to initiate various operations with third-party services 128, such as navigation services, food delivery services, ride sharing services, ecommerce services, websites, platforms, etc.

Routing application 112 can be, for example, instructions, an ‘app,’ module, etc. executed at device 110 that generates/provides notifications, information, updates to user 130 (e.g., a driver or delivery person) regarding various orders, deliveries, etc. For example, routing application can receive information from server 120 regarding new order(s) the driver can pick up (e.g., from a restaurant, grocery store, etc.) in order to perform a delivery. Routing application 112 can route the user to the corresponding locations (e.g., using various navigation techniques/technologies, including but not limited to one or more of application(s) 111, such as a navigation application).

For example, the driver can first be routed to a grocery store to pick up the order(s), and then (upon determining that the driver has received the orders for delivery) to the first (and then second, third, etc.) delivery on the driver's delivery route. Additionally, routing application 112 can configure device 110 to communicate with various other devices, services, etc., (e.g., server 120) in order to update such devices, etc. regarding the user's present location. In doing so, the real-time location of various drivers/devices can be accounted for in (a) assigning particular deliverie(s) to particular driver(s), (b) in providing delivery timeframe estimates to ordering users, and/or in performing various other operations, such as are described herein.

It should be noted that while application(s) 111 and 112 are depicted and/or described as operating on a device 110, this is only for the sake of clarity. However, in other implementations such elements can also be implemented on other devices/machines. For example, in lieu of executing locally at device 110, aspects of application(s) 111 and 112 can be implemented remotely (e.g., on a server device or within a cloud service or framework).

As shown in FIG. 1, the described technologies can include, incorporate, and/or otherwise interact with various item(s)/container(s) 150. Such an item can be, for example, a perishable item such as cold or frozen food, a biological substance (whose temperature is to be preserved for safety), or any other element with respect to which it may be advantageous or necessary to maintain a temperature, degree of moisture, state, or any other such observable phenomenon. Such a container can be, for example, a storage receptacle such as a cooler, insulated pouch, thermos, or any other such container capable of holding one or more of the referenced items (e.g., frozen or warm food). It should be understood that these examples are provided for purposes of illustration and that other items, containers, etc., can also be utilized or substituted.

In certain implementations, item(s)/container(s) 150 can include, incorporate, and/or otherwise interact with various item sensor(s) 152. Such item sensors can be, for example, temperature sensors, moisture/humidity sensors, gas sensors, and/or any other devices capable of perceiving or detecting various observable phenomenon. In certain implementations, the referenced item sensor(s) can be configured with communication interface(s), such as Bluetooth, Bluetooth Low Energy (BLE), NFC, Wifi, etc., transmitters and/or receivers. Additionally, in certain implementations the referenced item sensor(s) can be configured with a battery and/or other such power supply. In doing so, the item sensor(s) can be configured (e.g., using various Internet of Things (IoT) protocols) to communicate data, results, and/or other phenomena (e.g., the temperature of an item or container) to (and/or receive data and/or commands, instructions, etc., from) network 160, service 120, service(s) 128, and/or device(s) 110.

By way of illustration, in certain implementations, item 150 (as shown in FIG. 1) can be a frozen food item with respect to which sensor 152 is affixed. In another implementation, container 150 can be a cooler or insulated pouch (within which a cold or frozen item can be stored) that incorporates or integrates sensor 152.

In certain implementations, inputs, data, results, etc., originating from sensor(s) 152 can be communicated to server 120, device 110, service(s) 128, etc., on a periodic or ongoing basis. For example, item sensor(s) 152 can be affixed to an item 150 (e.g., a frozen item) and the temperature, humidity level, etc. of such item can be communicated to server 120 or service 128 on an ongoing or periodic basis (e.g., once a minute). In doing so, the rate at which the temperature, humidity, etc. of the item, container, etc., is changing can be determined, monitored, tracked, etc., (e.g., by server 120, device 110, service 128, etc.), as described herein. By way of further example, item sensor(s) 152 can provide such inputs (e.g., temperature, humidity level, etc. of the item) to device 110A (e.g., a device associated with a user tasked with delivering the item). Such a device 110A can process such inputs (e.g., to determine whether to adjust aspects of the delivery of the item) and/or can relay or transmit such inputs to server 120 or service 128, etc. as described herein.

Server 120 can be a rackmount server, a router computer, a personal computer, a mobile device, a laptop computer, a smartphone, a tablet computer, a camera, a video camera, a netbook, a desktop computer, a media center, any combination of the above, or any other such computing device capable of implementing the various features described herein. Server 120 can include components such as dispatch engine 142, coordination engine 144, and data repository 140. In certain implementations, server 120 can also include and/or incorporate various sensors and/or communications interfaces (including but not limited to those depicted in FIG. 2 and described in relation to device(s) 110. The components can be combined together or separated in further components, according to a particular implementation. Additionally, in some implementations, various components of server 120 may run on separate machines (for example, repository 140 can be a separate device). Moreover, some operations of certain of the components are described in more detail herein.

Data repository 140 can be hosted by one or more storage devices, such as main memory, magnetic or optical storage-based disks, tapes or hard drives, NAS, SAN, and so forth. In some implementations, repository 140 can be a network-attached file server, while in other implementations repository 140 can be some other type of persistent storage such as an object-oriented database, a relational database, and so forth, that may be hosted by the server 120 or one or more different machines coupled to server 120 via the network 160, while in yet other implementations repository 140 may be a database that is hosted by another entity and made accessible to server 120. In other implementations, repository 140 can be implemented as within a distributed or decentralized system/environment (e.g., using blockchain and/or other such distributed computing/storage technologies).

In certain implementations, repository 140 can store data pertaining to and/or otherwise associated with various requests, locations, and/or other information. In certain implementations, such stored information can pertain to aspects of delivery requests (e.g., grocery orders for delivery, etc.). In certain implementations, such requests/orders can originate and/or be received from various services such as service 128A and service 128B (collectively, services 128).

For example, as shown in FIG. 1, repository 140 can include one or more requests such as request 146A, request 146B, etc. (collectively, request(s) 146). Such requests can include and/or incorporate information associated with various requests, orders, etc., that are received, e.g., from various users, services, etc. For example, in certain implementations a request can include contents of a food delivery order (e.g., menu items), a location identifier (e.g., an address to which the order is to be delivered to), a user identifier (e.g., the name and/or contact information of the user associated with the order) and/or other values, parameters, information (e.g., the time the order was placed, the time it must be delivered by, other requests or specifications, etc.).

Additionally, in certain implementations, one or more of the referenced requests 146 can be associated with one or more constraints (e.g., constraint(s) 148A, as shown). Such constraints can be, for example, various parameters, ranges, etc., within or with respect to which associated request(s)/order(s) are to be prepared, delivered, etc. Examples of such constraints include but are not limited to: time constraints pertaining to order preparation and/or packaging, time and temperature control requirements (e.g., for safety/health purposes), time constraints reflecting when an order must leave a restaurant, etc., in order to meet customer expectations, and/or other such customer expectations (which can vary, for example, with respect to a fixed delivery time, a particular timeframe, a certain time duration after an order is placed, etc.). Further aspects of the referenced constraints are described in detail herein.

Additionally, in certain implementations data repository 140 can store data pertaining to and/or otherwise associated with the state of various item(s)/container(s) 150, e.g., under various conditions(such as inputs 149A, as shown in FIG. 1 and described herein). In certain implementations, such data/inputs can be received from item sensor(s) 152. For example, inputs originating from item sensor(s) 152 can be received and stored, together with other associated environmental data (e.g., outside temperature at the location of the item, etc.). Accordingly, the referenced inputs can reflect the current and/or historic state of an item (e.g., the temperature of a food item to be delivered). Such inputs can be used to further determine how to dispatch or route a delivery associated with such an item (e.g., to ensure it is delivered while still safe to consume), as described in detail herein.

Services 128 can be, for example, third-party services that enable users to purchase goods for shipment, place grocery/food orders for delivery, and/or any other such services. Accordingly, upon receiving an order (e.g., for grocery delivery, flowers, gifts, etc.), such a service 128 can provide or transmit a request to server 120. Such a request can include, for example, contents of the order (e.g., grocery items), a location identifier (e.g., an address to which the order is to be delivered to), and/or other values, parameters, information (e.g., the time the order was place, the time it must be delivered by, etc.). In certain implementations, the referenced orders, information, etc., can be stored in repository 140. Accordingly, repository 140 can maintain real-time and/or historic records of orders received (e.g., orders submitted to a particular store).

Additionally, in certain implementations, repository 140 can store data pertaining to various drivers/delivery personnel, orders, etc., that are handled/managed by the described technologies. For example, as noted above, device(s) 110 (which may correspond to various drivers) can routinely provide their current geographic location to server 120. Such information can be stored (e.g., in repository 140), thereby reflecting real-time and/or historic record(s) of such locations. The referenced location(s) can be further accounted for in dispatching requests/orders, coordinating aspects of the preparation of such requests/orders, and performing other operations (e.g., as described herein).

As shown in FIG. 1, server 120 can also include dispatch engine 142 and coordination engine 144. Dispatch engine 142 can be, for example, an application, module, instructions, etc., executed and/or otherwise implemented by server 120 that enables the real-time distribution of various orders to respective drivers. For example, restaurant orders received from a food ordering service 128 can be associated with/distributed to various drivers based on various criteria (e.g., availability, location, capabilities, etc., of the driver(s), item/container temperature and/or rate of change of item temperature).

It can be appreciated that, in certain scenarios, various fulfillment resources (e.g., drivers available to make deliveries, vehicles available for delivery, insulated containers available for delivery, etc.) may be finite or limited. Additionally, in certain scenarios various factors such as environmental factors may affect the temperature or rate of change of the temperature of an item (e.g., warm weather may cause a frozen item to melt more quickly). In such scenarios, the described routing and dispatching of orders can be adjusted to account for the referenced actual and/or projected/expected changes in temperature, humidity, etc. For example, in scenarios in which a frozen item is dispatched under conditions that may cause the item to defrost more quickly (e.g., on a hot day, as determined based on ambient sensors, data from a third-party weather service, etc.), the referenced order can be dispatched immediately to a driver as soon as possible after the order is received. However, when such an item is ordered while the weather is colder (and thus the item is likely to defrost less quickly), it may be unnecessary to dispatch the order immediately. In such a scenario, the described technologies can, for example, be configured to wait a defined period of time (e.g., 10 minutes) to await another incoming order which can be delivered by a single driver together with the first received order. In doing so, the described technologies can increase efficiency by enabling other drivers to remain available to deliver other orders.

Accordingly, as described in detail herein, in certain implementations dispatch engine 142 can be configured to enable real-time item/container monitoring, quality/state projections, dynamic dispatching, and other associated features and functionality. For example, in scenarios in which an item (e.g., a frozen item) can be determined to be changing temperature (e.g., melting in the case of a frozen food, cooling off in the case of a warm/hot food, etc.) at a relatively faster rate, such a product can be dispatched to a driver immediately (e.g., in lieu of awaiting additional orders to be received/prepared and dispatching multiple orders together with a single driver). By way of further example, in scenarios in which an item (e.g., a frozen item) can be determined to be changing temperature (e.g., melting) at a relatively slower rate, such an order can be dispatched to a driver after a defined delay (e.g., five minutes) (e.g., in lieu of dispatching the order to a driver immediately). In doing so, the described technologies can utilize real-time monitoring of the temperature of items (e.g., perishable items) to improve or optimize delivery of such items in a manner that accounts both for satisfaction and safety of the recipient as well as finite delivery resources (e.g., only a certain number of drivers available at a given time).

By way of further illustration, in certain implementations various constraints can be defined or determined with respect to a particular request/order, product, etc. Such constraints can reflect various parameters, ranges, etc., within or with respect to which the referenced item(s), order(s), etc. are to be prepared, delivered, etc. Examples of such constraints include but are not limited to: time constraints pertaining to order preparation and/or packaging, time and temperature control requirements (e.g., for safety/health purposes, such as a frozen item only being safe if left out of a cold environment for one hour or less), time constraints reflecting when an order must leave a store, etc., in order to meet customer expectations, and/or other such customer expectations (which can vary, for example, with respect to a fixed delivery time, a particular timeframe, a certain time duration after an order is placed, etc.).

In certain implementations, the referenced constraints may be defined or determined by certain users (e.g., an administrator or authorized user associated with a store, as described herein). Additionally, in certain implementations the referenced constraints can be defined, determined, and/or computed (e.g., in an automated or dynamic manner) based on other constraints and/or other information provided to and/or accessed by the system (e.g., inputs, data, etc. originating from item sensor(s) 152).

By way of example, the referenced constraints can be defined as a predetermined time interval (e.g., an amount of time from receipt of the order that the order is to be prepared, dispatched for delivery, and/or delivered). In certain implementations, such a constraint can be defined or determined based on inputs or other information originating from item sensor(s) 152. For example, with respect to a frozen item, such a constraint can dictate that the item must be delivered before the item reaches a defined temperature, state, etc. (e.g., a frozen item must be delivered before it reaches a certain temperature, humidity level, etc.).

The referenced constraints can also reflect a time derived or determined based on another constraint. By way of example, based on a constraint reflecting that an order must be out for delivery no later than 20 minutes after it has been received, additional constraints can be computed reflecting a time by which the preparation, retrieval, packaging, etc. of various items must begin (e.g., a milkshake, which takes six minutes to prepare, must begin no later than 14 minutes after the order is received, while a scoop of ice cream, which take two minutes to prepare, must begin no later than 18 minutes after the order is received, in order to meet the referenced 20 minute delivery constraint).

Additionally, in certain implementations the referenced constraints can be computed based on a customer expectation or guarantee. For example, orders that are prepared can wait a certain period of time before being dispatched for delivery, though such orders must be dispatched no later than 10 minutes before the delivery time/estimate provided to the customer. Accordingly, in such a scenario, corresponding constraint(s) can be defined to reflect the referenced order dispatch requirement(s) (as computed based on the delivery time/estimate provided to the user).

Using the referenced constraint(s) (and other factors including real-time inputs from items sensors affixed to the referenced item, item sensors affixed to other items that have been recently delivered, historical data, etc.), the described technologies can further compute or project a maximum exposure/defrost time interval. As described herein, such an interval may change based on various factors including but not limited to: packaging of an item, container in which the item can be stored in the delivery vehicle (e.g., within a cooler), other cold or insulating items included in the order, outside temperature, etc.

By way of illustration, in a scenario in which a first order has been prepared and is ready for dispatch, and a perishable (e.g., frozen) item in such an order can be determined/projected not be likely to defrost for two hours (e.g., based on inputs from item sensor(s) and/or collected data and projections), the actual dispatch of such an order can be adjusted (e.g., extended by several minutes) to enable additional orders (e.g., those that may be ready for dispatch shortly) to be dispatched with the first order (e.g., to the same driver). In doing so, delivery resources can be more effectively and efficiently managed. For example, by extending the dispatch of the first order by two or three minutes, a second order may be completed and ready for dispatch (together with the first order) to the same driver. As a result, both the first order and the second order are more likely to be received by their respective recipients in a satisfactory manner (perhaps only delaying delivery of the first order by two or three minutes). In contrast, in a scenario in which the first order has been prepared and is ready for dispatch, and a perishable (e.g., frozen) item in such an order is determined/projected to be likely to defrost more rapidly (e.g., based on inputs from item sensor(s) and/or collected data and projections), the actual dispatch of such an order can be adjusted, e.g., to enable immediate dispatch of the first order, enable dispatch of the order to a driver best equipped to maintain temperature of the item (e.g., with a cooler in their vehicle, with air conditioning etc.).

In certain implementations, such a window/interval can be dynamically adjusted to further account for subsequent circumstances, phenomena, etc. For example, in a scenario in which the temperature of an item can be determined (e.g., based on inputs originating from the referenced item sensors) to be changing in a manner not originally projected, delivery of such an item (or other items/orders) can be adjusted accordingly. For example, if a frozen item can be determined to be melting faster than originally projected, the routing of such a delivery can be prioritized to ensure it is delivered as quickly as possible. By way of further example, if a frozen item can be determined to be melting slower than originally projected, the routing of such a delivery can be de-prioritized to ensure enable items that may be more perishable (e.g., warm items) to be delivered more quickly.

Moreover, in certain scenarios, after certain orders are dispatched it may be further determined that it may not be possible to successfully fulfill all of the orders (e.g., in a scenario in which many frozen orders are dispatched on a hot day and the driver is unexpectedly delayed). In such a scenario, the described technologies can determine (e.g., based on inputs from the referenced sensors) which of the orders can still be delivered (e.g., while still safe to consume) and which orders will not be successfully fulfilled. For those orders that are determined not to be fulfilled, the described technologies can further initiate additional dispatch instance(s), e.g., to send our a new (and safe to consume) item, e.g., via another driver. In certain implementations, the referenced determination(s) can further account for various additional factors such as the cost to replace orders, importance of certain orders, time elapsed since order receipt, estimated/guaranteed delivery time, etc., e.g., in determining which orders to fulfill and which to replace/initiate new delivery instances.

In addition to adjusting various aspects of the dispatch of the referenced items (e.g., once such orders are prepared), the described technologies can further coordinate, adjust, and/or improve/optimize various aspects of the packaging of the referenced items(s). Such adjustments can enable an establishment (e.g., a grocery store) to prepare, package, etc., a product (e.g., frozen/perishable food) in a manner best suited for the circumstances under which such a product is likely to be delivered. In certain implementations, the referenced adjustments can be initiated and/or managed by coordination engine 144 (e.g., an application/module that configures various devices and/or otherwise performs various operations as described herein). Additionally, as described herein, in certain implementations multiple orders or items can be grouped for delivery, e.g., in order to preserve the contents of the respective orders. For example, in lieu of immediately dispatching a first order containing frozen item(s), dispatch of such an order can be postponed (e.g., for a defined period of time, e.g., five minutes), to enable additional frozen orders to be completed, thereby enabling multiple frozen orders to be arranged and transported together (e.g., by a single driver). In doing so, the collective frozen items can serve to preserve each other's temperature, thereby benefitting all of the referenced orders.

In another example, the described technologies (e.g., coordination engine 144) can adjust aspects of the preparation or packaging of various items to improve or optimize such packaging in view of the circumstances under which the item may be delivered. That is, it can be appreciated that it may be advantageous for certain perishable items to be packed with each other and/or surrounded by insulating items (so that temperature can be maintained). Accordingly, upon determining that an order includes perishable items, such items can be directed to be packed together and/or together with insulating items.

It should be understood that though FIG. 1 depicts server 120 and devices 110 as being discrete components, in various implementations any number of such components (and/or elements/functions thereof) can be combined, such as within a single component/system.

It should also be noted that, in certain implementations, the described technologies (e.g., device 110, application(s) 111 and/or 112, dispatch engine 142, server 120, etc.) can provide valuable insights and/or updates to various participants. For example, the described technologies may provide drivers, delivery personnel, etc. with an interface through which information or updates regarding requests/orders and items can be accessed, viewed, and/or received. Through such an interface, a driver can be notified, for example, that a particular order includes perishable items. The described technologies can also provide the driver with guidance re: how to handle such items (e.g., where to position them within the vehicle, to use air conditioning within n the vehicle, etc.).

In certain implementations, the described technologies can also provide a single or unified user interface/experience, through which a user (e.g., a restaurant, merchant, etc., that is dispatching orders) can initiate, track, etc., deliveries, including those that are being completed by various drivers, delivery personnel, delivery vehicles, etc.

It should also be noted that while various aspects of the described technologies are described with respect to grocery/perishable item deliveries, such descriptions are provided by way of example and the described technologies can also be applied in many other contexts, settings, and/or industries. For example, the described technologies can also be implemented in settings/contexts such as taxi service, drones, and/or any other such services, such as services that leverage the location and/or capabilities of various participants/candidates and route tasks, jobs, etc., to such devices, users, etc., in a manner that enables such tasks, etc., to be efficiently completed (and/or completed in an effective manner, e.g., fastest, most cost effectively, etc.).

Additionally, as described herein, the described technologies can provide the customer receiving the order with a single, unified interface that can reflect activity pertaining to multiple orders being fulfilled by different delivery services.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

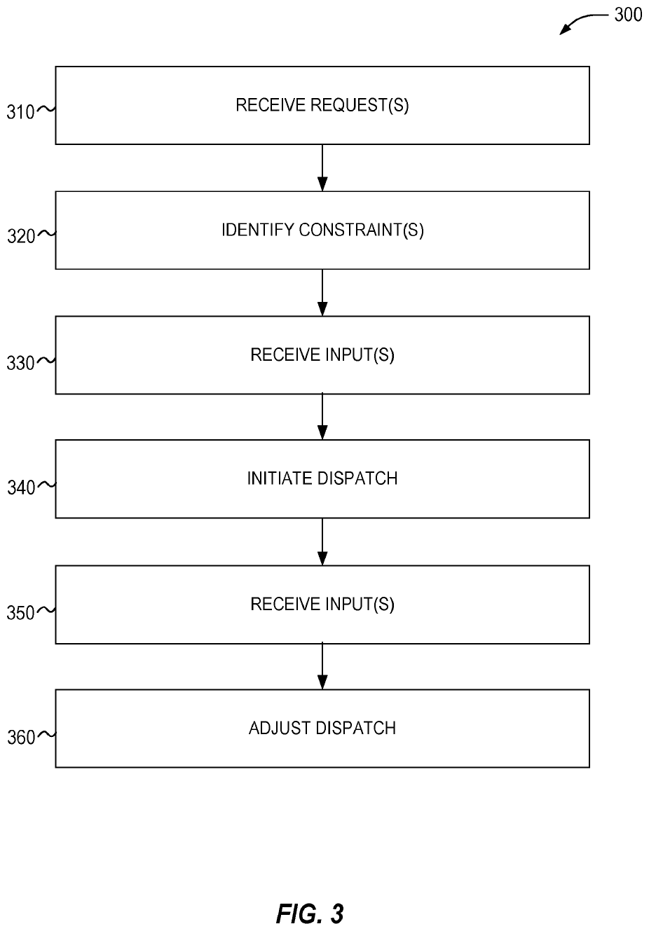

FIG. 3 is a flow chart illustrating a method 300, according to an example embodiment, for dynamic dispatch and routing based on sensor input. The method is performed by processing logic that can comprise hardware (circuitry, dedicated logic, etc.), software (such as is run on a computing device such as those described herein), or a combination of both. In one implementation, the method 300 is performed by one or more elements depicted and/or described in relation to FIG. 1 (including but not limited to server 120, dispatch engine 142, coordination engine 144, and/or devices 110), while in some other implementations, the one or more blocks of FIG. 3 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 310, a first request/order is received. In certain implementations, such a request/order can be received with respect to a first item. For example, an order for a perishable/frozen item can be received, as described in detail herein.

At operation 320, one or more constraints are identified or determined/computed. In certain implementations, such constraint(s) can be those associated with a first request (e.g., the request/order received at 310). Additionally, in certain implementations such constraints can be computed based on the first request. For example, as described in detail herein, in certain implementations, such constraints can be parameters, requirements, etc., associated with the referenced request/order, etc. For example, as described herein, in certain implementations various constraints can be defined or determined with respect to a particular request/order. Such constraints can reflect various parameters, ranges, conditions, etc., within or with respect to which the referenced order(s) are to be prepared, delivered, etc. Examples of such constraints include but are not limited to: time constraints pertaining to order preparation and/or packaging, time and temperature control requirements (e.g., for safety/health purposes), time constraints reflecting when an order must leave a restaurant, etc., in order to meet customer expectations, and/or other such customer expectations (which can vary, for example, with respect to a fixed delivery time, a particular timeframe, a certain time duration after an order is placed, etc.).

Moreover, in certain implementations one or more second constraint(s) can be computed based on one or more first constraint(s). For example, in certain implementations the referenced constraints can be defined, determined, and/or computed (e.g., in an automated manner) based on other constraints and/or other information provided to and/or accessed by the system (e.g., data included in a received request/order, inputs originating from one or more sensors, etc.). By way of example, the referenced constraints can be defined as a predetermined time interval (e.g., an amount of time from receipt of the order that the order is to be prepared, dispatched for delivery, and/or delivered).

In certain implementations, the referenced constraints can also reflect a time derived or determined based on another constraint. By way of example, based on a constraint reflecting that an order must be out for delivery no later than 20 minutes after it has been received, additional constraints can be computed reflecting a time by which the preparation of various foods must begin (e.g., a milkshake, which takes six minutes to prepare, must begin no later than 14 minutes after the order is received, while ice cream, which take two minutes to prepare, must begin no later than 18 minutes after the order is received, in order to meet the referenced 20 minute delivery constraint).

Additionally, in certain implementations the referenced constraints can be computed based on a defined or determined customer expectation or guarantee. For example, orders that are prepared can wait a certain period of time before being dispatched for delivery, though such orders must be dispatched no later than 10 minutes before the delivery time/estimate provided to the customer. Accordingly, in such a scenario, corresponding constraint(s) can be defined to reflect the referenced order dispatch requirement(s) (e.g., as computed based on the delivery time/estimate provided to the user).

At operation 330, one or more first input(s) can be received. In certain implementations, such first input(s) can be received from a first sensor or sensors. Such a sensor can be, for example, and environment sensor, a temperature sensor, a humidity sensor, a gas sensor, etc. (which may be configured with IoT capabilities and be affixed to a frozen item) such as are described herein. Additionally, in certain implementations such a sensor can be configured in relation to the first item (e.g., a perishable food item with respect to which the referenced order/request was received, as described herein). Based on such input(s), a state of the item can be determined, as described herein.

At operation 340, a first dispatch instance can be initiated. Such a dispatch instance can include or reflect, for example, a plan and/or other aspects of the manner in which a request/order is to be fulfilled. Such a dispatch instance can reflect various fulfillment resources (e.g., a driver/delivery person, vehicle, container, etc.) to be used in transporting or otherwise fulfilling an order. In certain implementations, such a dispatch instance can be initiated based on one or more constraints (such as those identified/determined at 320). Moreover, in certain implementations, such a dispatch instance can be initiated based on one or more inputs (such as those received at 330).

Moreover, in certain implementations a rate of change associated with one or more states of the first item can be determined (e.g., the rate at which a product is melting/warming up). Additionally, in certain implementations a chronological interval by which the first item is to expire can be computed (e.g., a time at which a perishable food item may no longer be safe to eat), as described herein.

Additionally, in certain implementations, the referenced first dispatch instance can be initiated based on a second request. For example, as described herein, various other requests/orders (e.g., orders for other products to be delivered to other customers) can be accounted for in routing or dispatching a first order.

In certain implementations, the first dispatch instance can be initiated with respect to a first user/driver, a first vehicle, and/or with respect to a first device (e.g., an insulated storage container). Moreover, in certain implementations the referenced first dispatch instance can be initiated based on an availability of one or more fulfillment resources. For example, the availability of a user/driver/delivery person, vehicle, container, etc. to be used in transporting or otherwise fulfilling an order can be accounted for in routing or dispatching a first order. Additionally, in certain implementations the referenced first dispatch instance can be initiated based on one or more items (e.g., one or more other items included in one or more other orders, such as other perishable items that, when arranged together, can serve to preserve the temperature of the items for a longer period of time as compared to when not arranged together).

At operation 350, one or more second inputs can be received. In certain implementations, such inputs can be received from the first sensor (e.g., the same sensor as the inputs received at 330). Such inputs can reflect, for example, an updated temperature, humidity, gas reading, etc., associated with the item. In other implementations, such second inputs can be received from a second sensor, such as an ambient sensor (reflecting, for example, the temperature, humidity, etc., proximate to the item, or in a location towards which the first item is being routed). In certain implementations, such a second sensor can be configured in relation to the first item. In other implementations, such a second sensor can be configured in relation to a second item (e.g., another item or order).

At operation 360, the first dispatch instance (e.g., as initiated at 340) is adjusted. In certain implementations, such a dispatch instance can be adjusted based on the one or more second inputs (e.g., as received at 350), as described in detail herein. Additionally, in certain implementations, a first operation can be initiated with respect to the first dispatch instance (for example, by routing the item in another manner, making other changes, etc., as described herein). Moreover, in certain implementations, a second dispatch instance can be initiated (for example, by sending out another item, e.g., when a first item is determined not be deliverable, as described herein).

It should also be noted that while the technologies described herein are illustrated primarily with respect to the delivery of food, items, services, etc., the described technologies can also be implemented in any number of additional or alternative settings or contexts and towards any number of additional objectives.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a processor or other programmable processor. Once configured by such software, hardware modules become specific machines (or specific components of a machine) uniquely tailored to perform the configured functions. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a processor configured by software to become a special-purpose processor, the processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described herein are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 4 is a block diagram illustrating components of a machine 400, according to some example implementations, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein can be executed. The instructions 416 transform the machine into a particular machine programmed to carry out the described and illustrated functions in the manner described. In alternative implementations, the machine 400 operates as a standalone device or can be coupled (e.g., networked) to other machines. In a networked deployment, the machine 400 can operate in the capacity of a server machine or a client machine in a server-client network environment, or as a peer machine in a peer-to-peer (or distributed) network environment. The machine 400 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 can include processors 410, memory/storage 430, and I/O components 450, which can be configured to communicate with each other such as via a bus 402. In an example implementation, the processors 410 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 412 and a processor 414 that can execute the instructions 416. The term “processor” is intended to include multi-core processors that can comprise two or more independent processors (sometimes referred to as “cores”) that can execute instructions contemporaneously. Although FIG. 4 shows multiple processors 410, the machine 400 can include a single processor with a single core, a single processor with multiple cores (e.g., a multi-core processor), multiple processors with a single core, multiple processors with multiples cores, or any combination thereof.

The memory/storage 430 can include a memory 432, such as a main memory, or other memory storage, and a storage unit 436, both accessible to the processors 410 such as via the bus 402. The storage unit 436 and memory 432 store the instructions 416 embodying any one or more of the methodologies or functions described herein. The instructions 416 can also reside, completely or partially, within the memory 432, within the storage unit 436, within at least one of the processors 410 (e.g., within the processor's cache memory), or any suitable combination thereof, during execution thereof by the machine 400. Accordingly, the memory 432, the storage unit 436, and the memory of the processors 410 are examples of machine-readable media.

As used herein, “machine-readable medium” means a device able to store instructions (e.g., instructions 416) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 416. The term “machine-readable medium” shall also be taken to include any medium, or combination of multiple media, that is capable of storing instructions (e.g., instructions 416) for execution by a machine (e.g., machine 400), such that the instructions, when executed by one or more processors of the machine (e.g., processors 410), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 450 can include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 can include many other components that are not shown in FIG. 4. The I/O components 450 are grouped according to functionality merely for simplifying the following discussion and the grouping is in no way limiting. In various example implementations, the I/O components 450 can include output components 452 and input components 454. The output components 452 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 450 can include biometric components 456, motion components 458, environmental components 460, or position components 462, among a wide array of other components. For example, the biometric components 456 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 458 can include acceleration sensor components (e.g., accelerometer), gravitation sensor components, rotation sensor components (e.g., gyroscope), and so forth. The environmental components 460 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 462 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 450 can include communication components 464 operable to couple the machine 400 to a network 480 or devices 470 via a coupling 482 and a coupling 472, respectively. For example, the communication components 464 can include a network interface component or other suitable device to interface with the network 480. In further examples, the communication components 464 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 470 can be another machine or any of a wide variety of peripheral devices (e.g., a peripheral device coupled via a USB).

Moreover, the communication components 464 can detect identifiers or include components operable to detect identifiers. For example, the communication components 464 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 464, such as location via Internet Protocol (IP) geolocation, location via Wi-Fi® signal triangulation, location via detecting an NFC beacon signal that can indicate a particular location, and so forth.

In various example implementations, one or more portions of the network 480 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 480 or a portion of the network 480 can include a wireless or cellular network and the coupling 482 can be a Code Division Multiple Access (CDMA) connection, a Global System for Mobile communications (GSM) connection, or another type of cellular or wireless coupling. In this example, the coupling 482 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 416 can be transmitted or received over the network 480 using a transmission medium via a network interface device (e.g., a network interface component included in the communication components 464) and utilizing any one of a number of well-known transfer protocols (e.g., HTTP). Similarly, the instructions 416 can be transmitted or received using a transmission medium via the coupling 472 (e.g., a peer-to-peer coupling) to the devices 470. The term “transmission medium” shall be taken to include any intangible medium that is capable of storing, encoding, or carrying the instructions 416 for execution by the machine 400, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense

What is claimed is:

1. A system comprising:
a processing device; and
a memory coupled to the processing device and storing instructions that, when executed by the processing device, cause the system to perform operations comprising:
receiving a first request with respect to a first item;
identifying one or more constraints associated with the first request;
receiving one or more first inputs from a first sensor configured in relation to the first item;
initiating, based on (a) the one or more constraints and (b) the one or more inputs, a first dispatch instance;
receiving one or more second inputs; and
based on the one or more second inputs, adjusting the first dispatch instance.

2. The system of claim 1, wherein the sensor comprises an environment sensor.

3. The system of claim 1, wherein the sensor comprises a temperature sensor.

4. The system of claim 1, wherein the sensor comprises a humidity sensor.

5. The system of claim 1, wherein identifying one or more constraints comprises computing the one or more constraints based on the first request.

6. The system of claim 1, wherein identifying one or more constraints comprises computing a second constraint based on a first constraint.

7. The system of claim 1, wherein receiving one or more second inputs comprises receiving one or more second inputs from the first sensor.

8. The system of claim 1, wherein receiving one or more second inputs comprises receiving one or more second inputs from a second sensor.

9. The system of claim 8, wherein the second sensor is configured in relation to the first item.

10. The system of claim 8, wherein the second sensor is configured in relation to a second item.

11. The system of claim 1, wherein initiating a first dispatch instance comprises determining a rate of change associated with one or more states of the first item.

12. The system of claim 1, wherein initiating a first dispatch instance comprises computing a chronological interval by which the first item is to expire.

13. The system of claim 1, wherein initiating a first dispatch instance comprises initiating the first dispatch instance further based on a second request.

14. The system of claim 1, wherein initiating a first dispatch instance comprises initiating the first dispatch instance further based on an availability of one or more fulfillment resources.

15. The system of claim 1, wherein initiating a first dispatch instance comprises initiating the first dispatch instance with respect to a first user.

16. The system of claim 1, wherein initiating a first dispatch instance comprises initiating the first dispatch instance with respect to a first vehicle.

17. The system of claim 1, wherein initiating a first dispatch instance comprises initiating the first dispatch instance with respect to a first device.

18. The system of claim 1, wherein initiating a first dispatch instance comprises initiating the first dispatch instance with respect to one or more items.

19. The system of claim 1, wherein adjusting the first dispatch instance comprises initiating a first operation with respect to the first dispatch instance.

20. The system of claim 1, wherein adjusting the first dispatch instance comprises initiating a second dispatch instance.

21. The system of claim 1, wherein adjusting the first dispatch instance comprises initiating a second dispatch instance with respect to a second item.

22. A method comprising:
receiving a first request with respect to a first item;
identifying one or more constraints associated with the first request;
receiving one or more first inputs from a first sensor configured in relation to the first item;
initiating a first dispatch instance with respect to the first item based on (a) the one or more constraints, (b) the one or more inputs, and (c) a second request received with respect to a second item;
receiving one or more second inputs; and
based on the one or more second inputs, adjusting the first dispatch instance.

23. A non-transitory computer readable medium having instructions stored thereon that, when executed by a processing device, cause the processing device to perform operations comprising:
receiving a first request with respect to a first item;
identifying one or more constraints associated with the first request;
receiving one or more first inputs from a first sensor configured in relation to the first item;
initiating, based on (a) the one or more constraints and (b) the one or more inputs, a first dispatch instance;
receiving one or more second inputs; and
based on the one or more second inputs, initiating a second dispatch instance with respect to a second item.
